(19) United States
(12) Patent Application Publication
(10) Pub. No.: US 2008/0021135 A1
(43) Pub. Date: Jan. 24, 2008

(54) Cellulose Reinforced Resin Compositions

(75) Inventors: James E. Garft, Yardley, PA (US); Brian L. Gibson, Bloomfield, NJ (US); Francis Sim, Allentown, PA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/592,809

(22) PCT Filed: Mar. 15, 2005
(86) PCT No.: PCT/US05/08496

§ 371 Date: Oct. 5, 2007

Related U.S. Application Data
(60) Provisional application No. 60/553,432, filed on Mar. 15, 2004.
(60) Provisional application No. 60/584,546, filed on Jun. 30, 2004.

(51) Int. Cl. C08L 91/06; C08L 1/00

(52) U.S. Cl. 524/13; 508/459; 508/465; 524/275; 524/35

(57) ABSTRACT

The present invention provides a shapeable reinforced resin-containing composition comprising resin capable of plastic flow, reinforcing material, and a lubricant composition comprising oxidized polyethylene wax, ester wax, and zinc stearate. Also provided are the lubricant composition, and shaping methods and shaped products based on the present compositions.

### CROSS REFERENCE TO RELATED APPLICATIONS

The present provisional application is related to and claims the priority benefit of U.S. Provisional Application No. 60/553,432, filed Mar. 15, 2004 and U.S. Provisional Application No. 60/584,546, filed Jun. 30, 2004, each of which is incorporated herein by reference.

### FIELD OF THE INVENTION

The present invention is related to reinforced resin-containing compositions, lubricant compositions for use in the preparation of such compositions, shaped products formed from such compositions, and processes for forming such shaped products.

### BACKGROUND OF THE INVENTION

Shapeable compositions, such as extrudable compositions, comprising cellulose fiber, for example, wood fiber, and resin, for example, a thermoplastic resin such as polyvinyl chloride, are well known. Examples of such compositions are described in U.S. Pat. Nos. 6,103,791 and 6,248,813 to Zehner and U.S. Pat. No. 6,210,792 to Seetharnraju et al, each of which is hereby incorporated by reference. These types of compositions can be extruded to provide shaped articles, for example, deck board and guard rails for exterior structures. Extruded compositions based on polyvinyl chloride resins (PVC) are frequently preferred for such applications because of their superior weather-resistant properties over other types of resin compositions. It is generally desirable that extruded products intended for such applications exhibit structural properties, as well as weather resistance and appearance that rival or exceed those of natural wood products frequently used in such applications.

In general extrusion of thermoplastic resin compositions which comprise a reinforcing material, for example a cellulose/polyvinyl chloride resin composition, requires heating an extrudable mixture to a temperature at which it can undergo plastic flow, and then forcing it through a plate containing one or more openings (herein, a “die”) which impart a profile shape to the emerging extrudate. The extrudate is thereafter cooled until it achieves the desired relatively rigid profile shape. The shaped extrudate is used either in its extruded form, for example, as a deck board or a railing, or it may be cut into convenient length pieces and packaged for use in follow-on processing, for example, as feedstock for an injection or blow molding process.

Shapeable feedstock compositions, which are also referred to herein for convenience as “shapeable compositions”, are often prepared by combining cellulose fiber, a resin and other constituents (also called additives) which effect the properties of the composition and articles formed therefrom. Once combined, it is common for the constituents of the shapeable composition to be “fused,” that is, subjected to heating and blending until a substantially homogeneous plastic composition is formed. The term “fusion” is applied to this process because in heating and blending the boundaries of the individual granules of the constituents become indistinguishable, thus, “fused”.

Dimensional stability and surface appearance (surface roughness) are characteristics that frequently affect the commercial value shaped products, particularly extruded products, and hence of the processes and the components used to make the product. Dimensional stability is assessed by observing the amount by which a shaped article expands during solidification after it emerges from the shaping apparatus, such as the die of an extruder. The amount of expansion is sometimes referred to as swell or die swell. Surface gloss is measured in accordance with known standard measurements, for example, ASTM standards D-2523-95 and D2457-97. Surface roughness is determined by visual and tactile evaluation. Surface roughness is also reflected in the degree to which the surface “seals”, that is, how resistant to water infusion the shaped article is as measured in accordance with ASTM D 570-98.

Important also to the commercial value of a shaped product, particularly an extrudate product, are the mechanical properties of the shaped article, for example, tensile strength, flexural strength, modulus of rupture, and apparent modulus of elasticity. These mechanical properties can be effected by the type and amount of lubricant included in the shapeable composition preparatory to producing the shaped article. These mechanical properties can be evaluated in accordance with known standard measurements, for example ASTM standards D 638 for measurement of the tensile strength, ASTM D 6109-97e1 or ASTM D 6109-03 for the evaluation of flexural strength as it applies to the apparent modulus of elasticity and modulus of rupture of structural materials, and the testing of the load-bearing properties of structural materials as determined by, for example, ASTM D4761-02 a.

For a given shapeable composition, it is generally possible to adjust the operating parameters of the shaping equipment to vary the rate at which material is shaped. However, maximizing shaping rate has practical limitations. For example, in the case of extrusion, it is possible to obtain extrusion rate increases by operating the extruder at a higher temperature and/or at a higher head pressure. However, at some point of increasing extruder temperature the extrudable composition will generally begin to scorch, and the surface and structural qualities of the extrudate will begin to degrade. Furthermore, as the head pressure or extruder torque is increased, a point is generally reached at which the dimensional stability and/or surface condition of the extruded material is unacceptable.

It has heretofore been known to achieve higher shaping rates by increasing the amount of lubricant incorporated into the shapeable extrudable composition. However, the use of increased amounts of lubricants in certain cases causes a reduction in cohesive ability of the resin in general and may also to lead to a reduction in the tensile strength of a shaped product produced from the shapeable composition. In other cases, increasing the amount of lubricant decreases the binding interaction between the resin and the fiber and thereby reducing the strength and load-bearing qualities of a product prepared from such a shapeable mass.

Accordingly, increasing the amount of the lubricant or changing the type of lubricant, while potentially improving the shapeability properties of the shapeable composition, can have deleterious effects on the mechanical properties of the shaped product. In certain cases, it is also possible that certain types of lubricants, when used in very high proportions, can also negatively impact processing parameters, for example, the fusion time required to prepare a shapeable composition.

As the foregoing discussion illustrates, shapeability in general and extrudability, calenderability, and moldability of a shapeable composition, and the mechanical properties and appearance properties of a shaped article prepared therefrom are interrelated, and the combination of all of the effects on these related properties as a result of changes in the compositions are not readily predictable.

Applicants have thus come to recognize the need for reinforced shapable compositions, particularly extrudable, calenderable, injection moldable and compression moldable compositions which have desirable processing properties and which preferably also provide shaped articles which have desirable appearance properties and/or improved mechanical properties. In particular, applicants have recognized a need to provide shaped PVC-based compositions having shapeability properties which are equal to or improved over those heretofore used and preferably to also provide a shaped article having equal or superior appearance and mechanical properties. These and other needs are addressed by one or more aspects of the present invention.

### SUMMARY OF THE INVENTION

One aspect of the present invention provides shapeable, and preferably extrudable compositions, which exhibit comparatively high processing rates, particularly extrusion rates, and in preferred embodiments are capable of being used to produce shaped articles with desirable appearance properties and/or mechanical properties. One preferred embodiment of the present shapeable compositons comprises:
(a) at least one thermoplastic resin;
(b) at least one reinforcing agent; and
(c) at least one ester wax.

Preferably, the ester wax component in such embodiments is present in an amount effective to improve the shapeability, and preferably the extrudability, canenderability, or moldability of the composition. Preferably, the processing properties improved in such shapeable compositions include comparable shaping rate at a given forming pressure or other forming parameter, such as torque setting in the case of extrusion.

Another aspect of the present invention involves shaped compositions and shaped articles comprising such compositions. Preferably the shapeable compositions of the present invention are formed by shaping, preferably extruding, a shapeable composition of the present invention and exhibit, relative to the same composition without the ester wax and formed by substantially the same shaping process, no substantial deleterious effects on, preferably an improvement in, and more preferably a substantial improvement in, one or more mechanical and/or appearance properties of the shaped composition. The noted mechanical properties in certain preferred embodiments comprise modulus of rupture and apparent modulus of elasticity. The noted appearance properties in certain preferred embodiments comprise surface roughness (as determined visually and/or as reflected in increased water infusion measurement in accordance with ASTM standard D 570-98).

Another aspect of the present invention provides lubricant compositons comprising ester wax which are particularly well suited for use in connection with the present shapeable compositons. In some preferred embodiments, the inventive lubricant composition provides improvement in the mechanical properties of a shaped article formed from a shapeable composition containing the lubricant composition without substantial deleterious effects on the processability of the composition or on the appearance properties of a shaped article prepared therefrom when compared to a shapeable composition of the same lubricant loading but substantially lacking one or more essential constituents of the inventive lubricant composition. In certain preferred embodiments the present shapeable compositions are capable of exhibiting one or more properties which are generally advantageous and/or desirable for the processing characteristics of the composition, while at the same time being capable of being shaped into a solid form with desirable properties, such as relatively high tensile strength and/or a relatively high degree of dimensional stability.

Another aspect of the present invention involves methods of forming shaped compositions comprising:
(a) providing an shapeable composition comprising:
   (i) at least one resin characterized in that it undergoes plastic flow;
   (ii) at least one reinforcing agent;
   (iii) a lubricant composition comprising ester wax, and preferably also oxidized polyethylene and zinc stearate; and
   (iv) optionally other additives; and
(b) shaping said said shapeable composition, preferably by exposing said shapeable composition to shear stress, preferably by forcing the composition through the nozzle of an injection molder, the nip of a calendering roll, or the die of an extruder, to form a shaped article.

Certain preferred embodiments of the present invention relate to compositions and methods which provide excellent operability in connection with the shaping of articles which involve relatively high pressure or high shear contact between the composition and one or more relatively hard surfaces (eg., metallic surfaces), such as the orifice of an extrusion die, the nip of a calendering rolls, and the mold cavities and the like in a mold. Such a process frequently occurs in the formation of shaped articles, such as the formation of resinous sheet material in a calendaring process or profiles by extrusion. As those skilled in the art are aware, metal release characteristics can be important in the formation/extrusion of such shaped articles in such processes since it is common in such processes to use one or more metal parts which contact the composition under high shear and/or compression in the process of forming the shapeable composition and/or in shaping of the shapeable mass, such as in the use of extrusion dies and calendering rollers of various configurations. Such techniques are frequently advantageous for use in connection with the formation of shaped PVC articles. Thus, in many embodiments it is particularly important to provide compositions and methods having good metal release properties while also exhibiting good physical properties of the shaped product. Accordingly, one aspect of the present invention provides methods of forming a shaped resinous article, and preferably PVC sheet, comprising:
(a) providing a shaping part having one or more relatively hard metallic surfaces;
(b) providing a composition comprising:
   (i) at least one resin characterized in that it is capable of undergoing plastic flow;
   (ii) a lubricant composition comprising ester wax and oxidized polyethylene; and
   (iii) optionally other additives; and
(c) intimately contacting said composition with said one or more relatively hard metallic surfaces under conditions effective to alter at least one physical property of the composition, the shape of the composition, or any two or more of these

### DETAILED DESCRIPTION OF THE PREFERRED EMBODIMENTS

The detailed description which follows is directed to shaping in the form of extrusion operations. However, presenting the description in this fashion is done primarily for the purposes of convenience, and those skilled in the art will be able to readily understand and use, in view of the specific and general teachings contained herein, the present invention in connection with other shaping processes, including those described above, and all such processes are within the scope of the present invention.

Applicants have surprisingly found that by including an effective amount of a lubricant composition of the invention in an extrudable composition which comprises at least one resin and at least one reinforcing material, the appearance properties of a shaped article prepared from the extrudable composition can be maintained or enhanced, and concomitantly, the mechanical properties of said shaped article can be maintained or improved when compared with a shaped article prepared using substantially the same extrusion process and the same extrudable composition but in the absence of a substantial amount of a lubricant composition of the invention.

Applicants have found that the present compositions and methods are well adapted for producing advantageous articles of manufacture, such as deck boards, railings, siding and like articles. The mechanical properties of these articles of the present invention compare favorably to those articles heretofore commonly used, particularly deck board.

It is contemplated that the present invention will have wide ranging applicability to extrusion of thermoplastic polymers (for example, PVC polymers, which are sometimes referred to herein for convenience as PVC resin) reinforced with cellulose materials, preferably wood fiber. While the present invention is described and illustrated below with respect to cellulose reinforced PVC extrudable compositions, it is believed that the inventive lubricant composition may have applicability to other extrudable compositions containing other resins and/or reinforcing material. For example, ram extrusion of reinforced polymer compositions containing one or more polymers which are not strictly thermoplastic, for example polytetrafluoroethylene (PTFE) may be beneficially affected by the present invention. Therefore, the term “extrudable composition” is used herein to refer not only to compositions that contain polymers having thermoplastic properties reinforced with cellulose reinforcing material, but also those polymers that are readily extrudable and/or behave similar to thermoplastic polymers with respect to extrusion processes and which are combined with a reinforcing material having properties similar to those of cellulose reinforcing material. Compositions, whether thermoplastic or otherwise, and such reinforcing materials, whether cellulose or otherwise, are sometimes referred to herein for convenience as reinforced resins.

### Definitions

The following definitions of certain terms relate to the description of the compositions of the invention and extruded articles prepared therefrom.

Dimensional stability refers to the tendency of extrudate to solidify in a shape that conforms to the die through which it was extruded. Without being bound by or to any particular theory, it is generally believed that as the extrusion temperature employed when forming an extrudate is reduced, the extruded material solidifies sooner after leaving the die. Furthermore, as the pressure used to force the extruded material from the die is reduced, there is generally imparted to the extruded material less residual elastic force which will be dissipated during the solidification of the extrudate. Furthermore, and again without being bound by or to any particular theory, it is generally believed that when comparing two extrudable compositions at the same throughput rate with all other extrusion conditions held constant, the composition extruded at a lower temperature (or if temperature is held constant, at a lower pressure) will provide an extrudate having reduced die swell, thus improved dimensional stability.

Without being bound by or to any particular theory, lubricants for use in extrudable compositions are believed to have internal and/or external lubricant properties. In general, it is believed that “internal lubricant” properties have an effect on the processability of an extrudable composition by reducing the cohesive forces which impart viscosity to the composition. By lowering these forces, it is believed that the polymer molecules which make up most of the mass of the composition are able to more easily “slip” past each other with greater ease when pressure is applied. In this manner, internal lubricants generally produce a decrease in the apparent viscosity of the extrudable composition permitting it to be extruded at lower pressure, all other extrusion factors being held constant.

Without being bound by or to any particular theory, it is generally believed that an external lubricant exudes from the mass of an extrudable composition and acts at the interface of the composition and a surface contacting the composition, for example at the point of contact with a metallic surface. The methods of the present invention then generally require shaping the provided composition, preferably by exposing the composition to shaping sheer forces, to form a shaped article. Preferably, the shaping step includes bringing the shapeable composition of the present invention to a temperature at which it can undergo plastic flow. In preferred embodiments this comprises heating the composition and forcing the shapeable composition under pressure through a relatively narrow or small opening created by at least one solid object. In the case of extrusion, for example, the opening is preferably in the form of a die containing one or more orifice openings or the like to impart a profile shape to the emerging extrudate. In the case of calendering, the opening is preferably formed by the nip between two rolls or between one roll and a blade, knife, or the like. In injection molding the opening is generally in the form of nozzle and/or channels/runners and/or mold cavities and features. In compression molding, a mass of the shapeable composition is placed in an appropriate mold cavity and is then shaped by exposure to compression under relatively high pressure, which in turn of course exposes the shapeable composition to shear as the composition is forced to flow into and around the mold cavities and other features of the mold.

Since this is the desired result of including an external lubricant in a composition, these lubricants are generally selected for the “metal releasing” properties imparted by their inclusion in a composition. This “metal releasing” property reduces the force required to overcome flow resistance through a conduit or an orifice (resistance to plastic flow). It is also preferred that this lubrication can occur without causing a substantial degradation of the qualities of the extrudate once it is formed, and in certain embodiments the surface qualities of extrudate may be relatively improved, such as by increasing the smoothness of the surface of an extruded article.

As described herein, certain of the preferred extrudable compositions of the invention and certain of the preferred shaped articles are characterized by their improved properties, as those properties are measured in comparison to extrudable compositions having substantially similar lubricant loadings but which do not contain the inventive lubricant composition. It will be apparent that numerous materials and compositions can be included in extrudable compositions which provide lubricating properties to the composition. Typically, an extrudable composition is described by the weight ratio of the constituents of the composition with reference to the weight of resin included in the composition. As the phrase is used herein, the “loading” of a particular constituent of an extrudable composition, for example, the “loading” of a lubricant composition in an extrudable composition, refers to the weight percentage of lubricant composition included in the extrudable composition relative to the parts by weight of resin included in the composition.

### Extruded Articles

The present invention is directed in one aspect to the preparation of extruded articles comprising PVC resin, reinforcing material, and ester wax. The extruded articles according to this aspect of the invention have appearance and mechanical properties equal to or superior to those of extruded articles comprising a similar loading of reinforcing materials and substantially lacking an ester wax, with at least one property preferably being superior. Appearance properties potentially relevant to the present invention include dimensional stability, surface roughness, and surface gloss of the extruded article. Potentially relevant mechanical properties which may be improved include the intrinsic flexural and tensile strength of extruded article, as well as the apparent modulus of elasticity, and modulus of rupture of the extruded article.

Improvements in appearance properties include a surface appearance which is visually equal to or smoother than those of comparative extruded articles substantially lacking an ester wax. The mechanical properties include improved dispersion of the reinforcing material, as determined by a procedure described below, and increased modulus of rupture and/or apparent modulus of elasticity of the article, as measured in accordance with Acceptance Criteria For Deck Board Span Ratings and Guardrail Systems, published by ICBO Evaluation Services, Inc. effective May 1, 2002, which is incorporated herein by reference.

The degree to which the reinforcing material is homogeneously dispersed throughout the extruded article can be determined by taking a cross-section of an extruded article, and visually inspecting the cross-sectional area for agglomerated material (as evidenced by a non-uniform appearance of the surface). Additionally the cross-sectional area is examined for the appearance of porosity (voids within the polymer matrix of the extruded article). In general, the preferred extruded articles of the present invention will display a more uniform cross-sectional surface when subjected to such examination due to improved dispersion of the reinforcing material when compared to extruded articles prepared from extrudable compositions lacking one or more essential constituents of the extrudable composition, whether alone in the form of a lubricant composition. In general, the preferred extruded articles of the invention will display a reduction or elimination of porosity.

Additional examples of reinforced extrude articles and the properties of merit and aspects of extrusion to be considered in preparing extruded articles are discussed in the attached Appendix A of 29 pages, entitled “Formulating to Enhance the Flexural Strength of PVC/Wood Composites,” and in attached Appendix B of 16 pages, entitled “Formulating to Enhance the Flexural Properties of PVC/Wood Composites.”

### The Methods

The present invention is directed in one aspect to methods of forming shaped articles, preferably from an extrudable composition comprising ester wax (preferably as a component of a lubricant composition of the present invention), a resin, preferably PVC resin, and in many embodiments a reinforcing material. As discussed in detail herein, the compositions of the invention provide, in addition to improvement in mechanical properties of an extruded article prepared therefrom, improvement in one or more of extrudability properties of the extrudable composition and appearance properties of the extrudate. Preferably, improvement according to the present invention is measured under standard conditions, in comparison to an extrudable composition containing a substantially similar weight percentage of lubricant, but substantially lacking one or more of the essential constituents of the present composition. An extrudable composition of such a description is referred to herein for convenience as a comparative extrudable composition. In some preferred methods, the shaped articles of the invention possess superior mechanical properties to the mechanical properties possessed by shaped articles formed from a comparative extrudable composition, and the extrudable composition from which shaped articles of the invention are prepared preferably possesses extrudability properties which are at least substantially equal to, and preferably superior to, those of the comparative extrudable composition. In some preferred embodiments, the shaped article possesses at least the same mechanical properties as an extrudate prepared from a comparative extrudable composition and at least one of the extrudability properties of the extrudable composition from which the shaped articles of the invention are prepared is superior to that of a comparative extrudable composition.

As the term is used herein, a comparative lubricant composition (which may contain only a single lubricant species) is one which lacks, either completely or to a substantial degree, one or more of the essential constituents of a lubricant composition of the invention.

The methods of the present invention preferably comprise providing a composition of the invention and exposing the composition to shear forces which cause the composition to change one or more of its physical properties, such as homogeneity, internal chemical structure (such as fusion) and shape (such as extruding an extrudable composition). As is known in the art, the requirements of an extrudable composition vary widely depending on the equipment being used to shape the shapeable composition and the desired properties of the extrudate formed thereby, among other factors, and it is contemplated that all such requirements can be satisfied by compositions within the scope of the present invention. For convenience, the properties of an extrudable composition are referred to herein as “the extrudability properties” of an extrudable composition. Although it is contemplated that the extrudable composition of the present invention may be provided by any means known in the art, it is generally preferred that the provided extrudable composition is formed by combining at least a resin, a reinforcing material, and a lubricating composition comprising one or more components which have a beneficial lubricating effect on the extrudable composition. When the lubricating composition comprises more than one component, the combination of components may be provided to the extrudable composition sequentially or simultaneously as individual components. Alternatively, in accordance with certain aspects of the invention, the combination of lubricating components can be provided as a mixture of constituents in the form of a separate lubricant composition.

Generally, an extrudable composition is provided by combining the components of the extrudable composition in a blending step which includes mixing the resin, the reinforcing material and other optional components if present, and the combination of lubricant components of the present invention. In preparing an extrudable composition, preferably, the mixture is heated externally and blended. Preferably the blending step causes additional shear heating within the composition. Preferably the combination of shear heating and heat from an external heat source causes the individual particles of the composition to soften and fuse, creating a substantially homogeneous mass. At the point of fusing (fusion point), the identity of individual particulates in the composition is preferably substantially lost.

The extrudability properties of compositions of the invention can be evaluated by performing such heating and blending operations under a fixed set of conditions and measuring certain aspects of the resulting mass. It will be appreciated that such tests can be carried out under any set of conditions which are suitable in consideration of the operating capabilities of the testing apparatus, for example, a torque rheometer, and which are compatible with the particular constituents selected for the composition to be tested. For convenience, any set of conditions selected for comparative evaluation of extrudable compositions are referred to herein as standard conditions. When standard conditions are used, the period of blending required to reach the fusion point is referred to as the “fusion time.” Under standard conditions, generally, at the fusion point, the viscosity of the composition is at a maximum, and it is at about this same point that a maximum will occur in the torque required to blend the mass. The torque maximum is related to the fusion viscosity and may be reported as fusion torque, either of which are properties of merit of an extrudable composition.

With continued blending under standard conditions, it is expected that the viscosity of the composition, and the torque required to blend the composition, will decrease to a relatively steady state condition. The steady state value is referred to as the equilibrium viscosity, the temperature of the composition at this point is referred to as the equilibrium temperature, and the torque required to blend the composition at the equilibrium temperature is referred to as equilibrium torque. At a particular temperature, either of the equilibrium torque or equilibrium viscosity are properties of merit of an extrudable composition and may, under appropriate circumstances, be used to compare the extrudability of different extrudable compositions. All of the aforementioned measurable properties of an extrudable composition can be used under appropriate circumstances as a basis of comparison of two different extrudable compositions.

With further continued blending under standard conditions, it is expected that at least certain compositions of the present invention would begin to cross-link and the viscosity of the composition, and hence the torque required for continued blending, would begin to rise. Under standard conditions, the elapsed time between the fusion point and the beginning of a measurable rise in viscosity due to cross-linking is referred to as the stability time. Under standard conditions, the stability time is also a property of merit of the extrudable composition and may, under appropriate circumstances, be used to compare the extrudablity properties of two different extrudable compositions.

Thus, the foregoing properties of an extrudable composition measured under standard conditions can be indicative of the extrudability properties of the extrudable composition. By measuring these properties under standard conditions, qualitative and quantitative comparison of the extrudabilty of various extrudable compositions can be made. Other extrudability properties can be measured by comparing compositions extruded from the same extruder under substantially the same conditions. Examples of these extrudability properties include the extrusion rate of the composition for a given extruder torque setting or value of head pressure.

The methods of the present invention also include extruding or shaping the provided shapeable composition to form a shaped article. Many particular shaping/extrusion techniques are well known in the art, and it is contemplated that all such techniques are adaptable for use in accordance with the present invention. In certain preferred embodiments, the step of extruding the composition comprises introducing the composition into a calendaring operation having at least two metallic calendaring rolls. Preferably, the extrusion step includes bringing the extrudable composition of the present invention to a temperature at which it can undergo plastic flow.

In certain preferred embodiments, the extrusion step comprises heating the extrudable composition and changing the shape of the composition by forcing the extrudable composition through a die containing one or more openings and/or calendering the composition between at least two metallic rolls. For embodiments in which a die is use, the openings in the die impart a profile shape to the emerging extrudate. In either case, the extrudate thus formed can be evaluated for appearance properties, as described above, which includes dimensional stability (die swell) and surface appearance (roughness, sealing). Accordingly, under fixed conditions, different extrudable compositions can also be evaluated and compared based on the amount of force required to force a given quantity per unit time of the extrudable composition through a die, calendaring rolls, or the like, and the extrudate prepared from different extrudable compositions compared based on their dimensional stability and appearance properties. Thus, another characteristic value of merit of the extrudable compositions of the present invention and extrudate prepared therefrom are the pressure or force needed to extrude the extrudable composition and/or the metal release properties of the composition. These quantities are determined with all other extrusion variables held constant. The force measured when the conditions of extrusion provide extruded articles from the extrudable compositions being compared in which the above-mentioned appearance qualities are substantially equivalent.

As mentioned above, one aspect of the present invention is improving the dispersion of a reinforcing material within an extrudable composition, and concomitantly, within an extruded article prepared from the composition. As is known, improving the dispersion of the reinforcing material in the composition can improve the mechanical properties of an extruded article prepared from such an extrudable composition, and provides for more cost-effective utilization of reinforcing materials. As is known also, improved dispersion of a reinforcing material can alter other measurable properties of the composition. For example, increasing the degree of dispersion of a reinforcing material in a PVC extrudable composition, all other factors being equivalent, can increase the apparent viscosity of the composition at a given temperature resulting in higher extruder torque necessary to extrude the composition at a given rate.

The methods of the present invention also include the provision of a shaped article having improved mechanical properties in comparison to a shaped article prepared under substantially similar extrusion conditions from a comparative extrudable composition having substantially the same loading of a comparative lubricant (standard comparison conditions). As will be appreciated, and as described above, various standards exist for evaluating various of the mechanical properties of a shaped article, including for example ASTM standards D 638 for measurement of the tensile strength, ASTM D 6109-031 for the evaluation of flexural strength as it applies to the apparent modulus of elasticity and modulus of rupture of structural materials, the testing of the load-bearing properties of structural materials as determined by, for example, ASTM D4761-02 a.

In accordance with the above-described properties of merit and standard comparison conditions, in some preferred embodiments, the extrudable composition of the invention contains an amount of a lubricant composition comprising a ratio of constituents selected to provide an extrudable composition having extrudablity properties which are at least equivalent to those of a standard extrudable composition whilst providing an extrudate therefrom which displays an increase in one or more of tensile strength, flexural strength, modulus of rupture, apparent modulus of elasticity (as measured in accordance with ASTM D6109-03 or ASTM D47 61-02a, both of which are incorporated herein by reference). More preferred are extrudable compositions which provide extruded articles of improved mechanical properties and which have improved extrudability. Even more preferred are extrudable compositions of the invention providing extrudates displaying these improved extrudability properties and provide an extruded article having at least one improved mechanical property and at least one improved appearance property, that is, surface roughness and/or sealing, gloss, and dimensional stability.

In accordance with the above-described properties of merit and standard comparison conditions, in some embodiments the constituents of the inventive lubricant composition and their weight ratio are selected, and the composition is included in a composition of the invention in an amount, which provides an composition, and preferably an extrudable composition, having a reduction in one or more of the following extrudability properties: fusion temperature, fusion time, force (as measured either by extruder head pressure or torque) required to extrude a given quantity of extrudable composition per unit time, and optionally in some embodiments metal release. More preferably, the constituents of the extrudable composition and their relative amounts are selected to provide at least about a 3% improvement, more preferably still at least about a 5% improvement, more preferably at least about a 10% improvement, and more preferably at least about a 20% improvement in at least one of the aforementioned extrudablity properties, whilst providing an extrudate therefrom which displays an improvement in one or more of tensile strength, flexural strength, modulus of rupture, apparent modulus of elasticity (as measured in accordance with ASTM D6109-03 or ASTM D4761-02a, both of which are incorporated herein by reference). More preferred are extrudates which have these improved extrudability properties and which provide an extruded article displaying an improvement of at least about 5%, more preferably at least about 10%, more preferably at least about 15%, and even more preferably at least about a 20% in the given mechanical property.

In accordance with the above-described properties of merit and standard comparison conditions, in some preferred embodiments, the components and ratio of a lubricant composition of the invention are selected, and the lubricant composition is included in an extrudable composition of the invention in an amount which provides an extrudable composition having extrudablity properties which are at least equivalent to those of a standard extrudable composition, preferably which have at least about a 2%, more preferably at least about a 5%, more preferably at least about a 10% improvement in at least one of the above-mentioned extrudability properties whilst providing an extrudate therefrom which displays an improvement in any one of surface roughness, surface gloss and dimensional stability and an in increase in one or more of tensile strength, flexural strength, modulus of rupture, apparent modulus of elasticity (as measured in accordance with ASTM D6109-03 or ASTM D4761-02a). More preferred are extrudates displaying one or more improved extrudability properties, and which provide an extruded article which has an increase of at least about 2%, more preferably at least about 5%, and even more preferably at least about a 10% increase in at least one appearance property and an increase in one or more of the above-mentioned mechanical properties. More preferred are extrudable compositions which provide the aforementioned improved extrudability properties and provide an extruded article with the aforementioned improved appearance properties and which provide at least a 5%, more preferably at least about a 10%, more preferably at least about a 20% increase in one or more of the aforementioned mechanical properties.

In accordance with the above-described properties of merit and standard comparison conditions, in some preferred embodiments, the components and ratio of a lubricant composition of the invention are selected, and the composition is included in an extrudable composition of the invention in an amount, which provides an extrudable composition from which a shaped article can be prepared which has an in increase in one or more of tensile strength, flexural strength, modulus of rupture, and apparent modulus of elasticity (as measured in accordance with ASTM D6109-03 or ASTM D47 6 1-02a) of at least about 10%, more preferably an increase of at least about 15%, more preferably an increase of at least about a 20%, and more preferably an increase in excess of 30%.

In some embodiments of the present invention it is preferred to use an amount of the lubricant composition of the present invention that is effective in reducing, under standard comparison conditions, the force required to force a given quantity per unit time of the extrudable composition through a die by at least about 2 percent, more preferably by at least about 5 percent, and even more preferably at least about 10 percent whilst providing an extrudate prepared from the extrudable composition which has preferably at least about 5 percent, more preferably at least about 10 percent, and even more preferably at least about 20 percent increase in one or more of tensile strength, flexural strength, modulus of rupture, and apparent modulus of elasticity (as measured in accordance with ASTM D6109-03 or ASTM D4761-02a). In such embodiments, it also generally preferred that the other extrudability properties of the extrudable composition of the invention are not substantially degraded in comparison with the comparative extrudable composition. In such embodiments it is also generally preferred that the appearance and mechanical properties of an extrudate product produced under standard conditions from the extrudable composition of the invention, as described in detail below, are improved in comparison with an extrudate prepared under standard conditions from a comparative extrudable composition of similar lubricant loading.

Without being bound by or to any particular theory, when combined in the ratios and amounts indicated below, the constituents of the lubricant composition of the present invention provides the internal and external lubricating properties required in an extrudable composition without providing the above-mentioned deleterious effects in the mechanical and appearance properties of an extrudate prepared therefrom.

In some preferred embodiments the lubricant composition of the present invention is used in an amount which provides an improvement in at least one of the above-described extrudability properties and/or an improvement in the degree to which the reinforcing material is dispersed, as measured in accordance with the visual procedure described herein. When the lubricant provides an improvement in the extrudability of the composition, preferably the lubricant composition is used in an amount which provides not only at least about a 2 percent reduction, more preferably at least about a 5 percent reduction, and more preferably at least about a 10 percent reduction in the resistance of an extrudable composition to plastic flow (in comparison to an extrudable composition using a similar amount of a comparative lubricant, the extrusion conditions being equal), but provides at least about a 5 percent, more preferably at least about a 10 percent, and more preferably at least about a 20 percent increase in one or more of the modulus of rupture, apparent modulus of elasticity, flexural strength and/or tensile strength of an extrudate product prepared from the extrudable composition of the invention (measured in accordance with ASTM D6109-03 or ASTM D4761-02a). The preferred methods of the present invention are thus capable of providing an extrusion step utilizing a relatively low head pressure and a relatively low torque required to drive the extrusion process, each of which is also a characteristic by which the extrudablity of the extrudable composition can be measured. In certain embodiments, the lubricant composition is preferably present in the composition in an amount effective to reduce the head pressure by at least about 5 percent, more preferably by at least about 10 percent, relative to the head pressure required with all other conditions being substantially the same except for the presence of the lubricant composition of the invention, and concomitantly provide at least about a 5 percent, more preferably at least about a 10 percent increase in the modulus of rupture, apparent modulus of elasticity, tensile strength and/or flexural strength of an extrudate product prepared from the extrudable composition of the invention. It is also preferred in certain embodiments that the lubricant composition is present in the extrudable composition in an amount effective to reduce the extrusion torque by at least about 2 percent, more preferably by at least about 5 percent, and even more preferably at least about 10 percent, relative to the extrusion torque required with all other conditions being substantially the same except for the presence of the lubricant composition and concomitantly provide at least about a 5 percent, more preferably at least about a 10 percent increase in one or more of the modulus of rupture, and/or apparent modulus of elasticity, and/or tensile strength and/or flexural strength of an extrudate product prepared from the extrudable composition (measured in accordance with ASTM D6109-63 or ASTM D4761-02a).

Certain preferred methods of the present invention are thus capable of providing an extrudate (extrusion product) having greatly improved dimensional stability. Preferably the lubricant composition of the invention is present in the extrudable composition in an amount effective to increase the dimensional stability of the extruded product and concomitantly provide an increase in one or more of the modulus of rupture, apparent modulus of elasticity, tensile strength and/or flexural strength of an extruded article prepared from the extrudable composition. Preferably the amount of lubricant composition used in the extrudable composition provides at least about 2 percent, more preferably by at least about 5 percent, and even more preferably at least about 10 percent improvement in dimensional stability relative to that of an the extruded article provided under the same extruder conditions from a comparative extrudable composition. Preferably, the concomitant increase in mechanical properties of an extruded article prepared from the extrudable composition of the invention at least about a 5 percent, more preferably at least about a 10 percent increase in at least one of the modulus of rupture, apparent modulus of elasticity, tensile strength and/or flexural strength in comparison to an extruded article prepared from the compartive extrudable composition, as measured in accordance with ASTM D6109-03 or ASTM D4761-02a.

As discussed above, and without wanting to be bound by or to any particular theory, an external lubricant reduces the adhesion between an extrudable composition and a surface contacting the composition. When the extrudable composition contains a reinforcing material, the tendency of the resin, which comprises to a substantial degree the bulk of the composition, to adhere to the die during extrusion, can act to pull reinforcing materials from the extrudable composition as it is leaving the die. This tendency yields a surface on an extrudate product which has a grainy or even pitted (“corn cobb”) appearance, lowering the commercial value of the extrudate. The quality of the extrudate surface is typically assessed by assessing its roughness and/or its reflectivity (gloss). The measurement of gloss is known, for example, ASTM standards D- 2523-95 and D2457-97. Change in roughness is determined by visual and/or tactile comparison of two surfaces. Surface roughness is also reflected in the degree of water infusion in an extruded article, as measured in accordance with ASTM D-570-98. As surface roughness increases, the surface is less well sealed and water infuses into the body of an extrude article under test to an increasing degree. Preferably the lubricant components of the present invention are present in the extrudable composition in an amount, when taken together, is effective to decrease water infusion by at least about 2 percent, more preferably by at least about 5 percent, and even more preferably at least about 10 percent, relative to that observed for an extruded article with all other conditions being substantially the same except for the presence of the lubricant composition of the invention, and concomitantly provide at least about a 5 percent, more preferably at least about a 10 percent increase in one or more of the modulus of rupture, and/or apparent modulus of elasticity, and/or tensile strength and/or flexural strength of an extrudate product from the extrudable composition (measured in accordance with ASTM D6109-03 or ASTM D4761-02a).

It may be found that certain lubricant compositions of the present invention may also act as a surfactant by improving wetting between (and thereby adhesion between) a reinforcing material and the resin component of the composition. This is demonstrated by the increase in one or more mechanical properties selected from the modulus of rupture, and/or apparent modulus of elasticity, and/or tensile strength, and/or flexural strength, and/or load bearing capacity.

As it emerges from the orifice opening or from between the calendaring rolls, etc, the shaped article is preferably cooled to produce a relatively rigid article having the basic shape imparted by the die or rolls. The shaped extrudate can be used either in its extruded form, for example, as a decorative molding, as fencing members, as siding for buildings, as windows members, as door jambs, as base board, as flashing, and like products, and all such products produced by the present methods or using the present compositions are within the scope of the present invention. The extrudate also may be cut into convenient length pieces and packaged for use in follow-on processing, for example, as feedstock for a injection or blow molding processes.

The present methods in preferred embodiments therefore comprise providing an extrudable composition comprising at least one polyvinyl chloride resin, a cellulose reinforcing constituent, and a lubricant composition of the invention. The lubricant composition of the invention is preferably present in an extrudable the composition in an amount effective to improve at least one mechanical property of an extrudate prepared therefrom while providing an extrudable composition which has desirable, preferable superior, extrudability properties. Accordingly, when compared to a comparative extrudable composition which has a substantially similar loading of lubricant but which is substantially lacking one or more constituents of the lubricant composition of the invention (comparative extrudable composition), the extrudability properties of the extrudable composition of the invention will be at least equivalent, and preferably at least one processing property will be improved. Concomitantly, the mechanical properties of an extruded article prepared from the extrudable composition of the invention will be improved when compared to an extruded article prepared from the comparative extrudable composition.

Preferably, the methods of the present invention produce improvement in at least one measure of extrusion performance and in one measure of extrudate appearance quality. More preferably, the present methods exhibit improved performance in each of the following: extrudability criteria (such as extrusion torque, head pressure and processing stability); an appearance property of an extrudate product prepared from the extrudable composition (such as surface roughness, gloss, and dimensional stability); and a mechanical property of an extruded article prepared therefrom (such as tensile strength, flexural strength, modulus of rupture, and apparent modulus of elasticity).

### The Compositions

The present invention provides extrudable compositions, additive compositions (including lubricant compositions) useful in the formulation of extrudable compositions, and extruded compositions (including shaped articles) formed from the extrudable compositions of the present invention.

### The Extrudable Compositions

The extrudable compositions of the present invention include a resin, a reinforcing material, a combination of ester wax and oxidized polyethylene wax, and zinc stearate. In certain embodiments the compositions may optionally include additional heat stabilizers, for example, calcium stearate and additionally lubricants, for example, paraffin wax. The combination of ester wax and oxidized polyethylene wax, and zinc stearate constituents when present, and optionally other constituents, for example, calcium stearate and paraffin wax, can be prepared as a separate composition. Whether added to an extrudable composition as separate components, or prepared as a separate composition and added to an extrudable composition as a mixture of constituents, these constituents are sometimes referred to herein for convenience as a “lubricant composition”. In addition to a resin, reinforcing material, and a lubricant composition, the present preferred extrudable compositions may optionally include other additives, including other constituents which may perform some of the same or similar functions in an extrudable composition, for example, other lubricant components, impact modifier(s), filler(s) (for example, calcium carbonate), heat stabilizer(s) (for example, tin based stabilizer such as TM281® from Rohm & Haas), processing aid(s) (for example acrylic copolymers), binder(s), colorant(s), and others, for example, those described in Handbook of Plastic Materials and Technology, Ed. I. Rubin, Wiley-Interscience, John Wiley & Sons, Inc. New York, 1990 and those described in Plastics Additives and Modifiers Handbook, Ed. J. Edenbaum, Van Nostrand Reinhold, New York 1992, Chapter 3, each of which is incorporated herein by reference.

Although extrudable compositions of the invention can be prepared which contain only a resin, a reinforcing material, at least one ester wax, at least one oxidized polyethylene wax, it will be appreciated that additional considerations may require the inclusion of other components. These considerations include the requirements of various processing equipment, requirements imposed by particular profile shapes to be extruded, and other art-recoginzed considerations. In some preferred embodiments an extrudable composition will comprise a lubricant composition which comprises paraffin wax, ester wax, oxidized polyethylene wax, zinc stearate and optionally calcium stearate Preferably, the amount and type of constituents of an extrudable composition of the present invention are chosen such that the composition exhibits one or more of the following properties, as determined under standard test conditions: lower fusion torque, lower equilibrium torque, reduction in fusion time, reduction in equilibrium temperature, and increase in processing stability (dynamic heat stability) and/or improvements in the dimensional stability, and/or the surface roughness, and/or the surface gloss of an extruded article (extrudate product) prepared by extruding the extrudable composition and/or metal release properties. As mentioned above, these characteristics will generally result in improvements in the characteristics of the extrusion process and or the appearance and utility, thus the commercial value of an extrudate product. Concomitant with the provision of an improvement in one or more of the aforementioned properties, the amount and type of constituents comprising the lubricant composition used in an extrudable composition of the present invention preferably provide also improved mechanical properties in an extrudate product prepared from the extrudable composition. Examples of improved mechanical properties include increases in one or more of flexural strength, tensile strength, modulus of rupture, and apparent modulus of elasticity. In other words, the inventors have found that inclusion of lubricant components in accordance with the present invention, described in detail herein, in a reinforced extrudable composition, preferably a composition comprising PVC and a cellulose reinforcing material, can provide compositions which display improved extrudability properties, and/or improvement in the dimensional stability, and/or the surface roughness, and/or the surface gloss of an extrudate product prepared from the extrudable composition when compared under the above-mentioned standard conditions to an extrudable composition having a substantially similar loading of a lubricant composition which lacks to a substantial degree one or more of the constituents of the lubricant composition of the invention (comparative extrudable composition). Concomitantly, the extruded articles prepared from the extrudable composition of the invention when compared under standard conditions to extruded article prepared for the comparative extrudable composition have improved mechanical properties.

In general, with respect to the processability properties of the extrudable composition, one or more of the following properties associated with processing of the extrudable composition with otherwise fixed extrusion parameters will be improved by including in the composition the lubricant composition of the present invention: (a) improved dispersion of the reinforcing material in the composition; (b) lower head pressure; (c) lower fusion torque; (d) lower extrusion temperature; (e) lower apparent viscosity; and metal release. In general, with respect to the appearance properties of an extruded article prepared from an extrudable composition of the invention by extrusion under otherwise fixed conditions: improvement in dimensional stability, and/or the surface roughness, and/or the surface gloss of the extrudate may be observed instead of or in addition to improvement in the above-mentioned processing properties. In addition to improvement in any one of or all of the above mentioned processing properties of the extrudable composition and the appearance properties of an extruded article prepared by extruding the extrudable compositions of the present invention, under standard conditions the extruded article prepared from a composition of the present invention display also an improvement in one or more of the mechanical properties: flexural strength, and/or tensile strength, and/or modulus of rupture, and/or apparent modulus of elasticity, as these mechanical properties are evaluated in accordance with the above-mentioned standards.

### The Resin

The extrudable compositions of the present invention may include thermoplastic resin or resins which exhibit thermoplastic properties or which are otherwise extrudable. Thus, it is contemplated that resins such as polycarbonates, ABS plastics and high engineering plastics may be used. It is generally preferred however, that the resin of the present compositions comprise, and preferably consist essentially of, vinyl based resin, that is, one or more polymers (including homopolymers, copolymers, terpolymers, etc.) that share the vinyl radical (CH₂=CH) as a starting structural unit. Particularly preferred is polyvinyl chloride (PVC), and in particular suspension, dispersion, emulsion or bulk PVC resins, with suspension and bulk PVC resins being preferred. In preferred embodiments, the PVC resin of the present invention has a Filentscher K-value of from about 50 to about 70, and even more preferably from about 55 to about 65.

### The Reinforcing Material

The extrudable compositions of the present invention, and extrudate products prepared therefrom, comprise predominantly a resin, described herein in detail, and in preferred embodiments admixed therewith, preferably substantially homogeneously dispersed therein, a reinforcing material, also sometimes referred to herein for convenience as a “reinforcing agent”. It will be appreciated also that the reinforcing material may have a wide variety of shapes, for example, fibers, chips, and particulates. Although a wide variety of reinforcing materials may be included (for example, fiber glass, talc, aramide fiber, and the like) preferably the reinforcing material comprises a cellulose material (also sometimes referred to herein for convenience as a cellulose reinforcing constituent). Examples of suitable cellulose reinforcing constituents include saw dust, wood chips, wood flour, bisal, hemp and flax. A commercially available cellulosic reinforcing fiber is, for example, 60 mesh southern yellow pine available from American Wood Fiber Co.

Next will be described the various components of the preferred lubricant composition, preferred methods for the preparation of the present extrudable compositions and lubricant compositions, and then examples of lubricant compositions and their use will be presented.

### Lubricant Compositions

One preferred lubricant composition for use in extrudable compositions of the invention and for use in preparing additive compositions of the invention comprises: (i) ester wax; (ii) oxidized polyethylene wax; and preferably (iii) zinc stearate. In some preferred lubricant compositions, calcium stearate and paraffin wax constituents are included also.

In some preferred embodiments, the weight ratio of the lubricant composition constituents is chosen such that when said lubricant composition is incorporated into an extrudable composition in an amount providing from about 2 wt. parts to about 5 weight parts lubricant composition per hundred weight parts resin, there is provided an extrudable composition which yields an extrudate having a modulus of rupture, as measured by ASTM D6109-97e1, exceeding that an extrudate prepared from extrudable an composition having the same lubricant loading but having a lubricant composition which is substantially lacking one or more essential constituents of the inventive lubricant composition. More preferably, a ratio is chosen that provides an increase in modulus of rupture of at least about 20%.

In one preferred embodiment, applicants' lubricant composition comprises: (a) ester wax; (b) polyethylene wax; (c) zinc stearate; (d) paraffin wax; and (e) calcium stearate, and the relative amounts of the constituents of the lubricant composition are selected to provide an advantageous increase in the tensile strength of an extrudate product prepared from said composition in comparison to an extrudate product prepared from an extrudable composition substantially lacking one or more of zinc stearate, ester wax, or oxidized polyethylene wax constituents. While not wanting to be bound by or to any particular theory, applicants believe that when the constituents of the lubricant compositions form part of a reinforced extrudable composition they improve the affinity of the resin for the reinforcing agent in the composition whilst providing lubricating properties and heat stabilization to the composition.

### Ester Wax Constituent

Examples of ester waxes suitable for use in the lubricant and extrudable compositions of the present invention include polymeric compounds which can be prepared by the condensation of a di- or polyfunctional carboxylic acid, for example, adipic acid, with a di- or polyfunctional alcohol, for example, pentaerytritol, in the presence of a monofunctional fatty acid, for example, stearic acid, or other monofunctional lipophilic organic acid. All of the aforementioned reactants are articles of commerce.

Preparation and use of various of the ester waxes has been described, for example, in U.S. Pat. No. 6,485,804 to Nakamachi, et al., U.S. Pat. No. 5,621,033 to Lindner, U.S. Pat. No. 5,039,740 to Anderson et al., U.S. Pat. No. 4,681,975 to Hasegawa et al., U.S. Pat. No. 4,454,313 to Okitsu et al., and U.S. Pat. No. 3,972,962 to Williams et al., each of which is incorporated herein by reference. In certain preferred embodiments, ester wax suitable for use in the lubricant composition of the present invention has the following properties: acid numbers of between about 1 to about 25 mg KOH/g of ester wax; and viscosity of from about 30 centipoise at 100° C. to about 160 centipoise at 176° C.

For use in the lubricant compositions of the present invention it is preferred if the ester wax has an acid number of from about 10 mg KOH 1 g of wax to about 18 mg KOH/g of wax and has a viscosity of about 50 centistokes at 115° C. More preferred are ester waxes comprising the condensation product of a reaction containing pentaerythritol: adipic acid: stearic acid in the wt. ratio of about 16:14:70 with a residual acid number, as measured by ASTM D-1316 of about 12 mg KOH/g of ester wax, and has a viscosity of about 50 centistokes at about 116° C.

Ester waxes suitable for use in the lubricant composition of the present invention are available commercially from Honeywell under the trade designation Rbeolub™ Specialty esters, including for example, Rheolub™ 710, Rheolub™ 830, and Rheolub™ 1800.

Other compounds which can be substituted in the present invention lubricant composition for the ester waxes described above include pentaerythritol-adipate-aleate, pentaerythritol-tetrastearate, pentaerythritol-monostreate, pentaerythritol-distearate, and mixtures of two or more thereof. Many of these are available as articles or commerce, for example, the Pentesters from Cognis.

### Oxidized Polyethylene Wax Constituent

Oxidized polyethylene polymers (hereafter oxidized polyethylene or OPE) have been known as surface active materials for many years. These materials are typically prepared from an olefinic polymer, for example, polyethylene, or a “polyethylene wax” olefinic-copolymer, for example, polyethylene/polybutadiene and polyethylene/polymethacrylic acid, by subjecting the polymer or copolymer to oxidation such that oxygen functionality, for example, in the form of carbonyl functional groups, is introduced into the polymer, making it less hydrophobic. Numerous publications describe the preparation and various uses of these materials, for example, U.S. Pat. No. 6,060,565 to Deckers et al., U.S. Pat. No. 4,459,388 to Hettche et al., U.S. Pat. No. 3,322,711 to Bush et al., and U.S. Pat. No. 3,234,197 to Bauum, the disclosures and references of which are incorporated herein by reference.

Examples of these materials are available commercially, for example, the A-C® Wax series of oxidized polyethylene materials available from Honeywell International Inc. (“Honeywell”).

For use in the present invention lubricant compositions, the oxidized polyethylene materials most useful have the following properties: (i) Brookfield viscosities ranging from about 200 (centipoises) cps at 140° C. to about 85,000 cps at 150° C.; and (ii) acid numbers, as determined by either ASTM D-1386, 305-OR-1, or TMP-OCL-006 ranging from about 5 mg KOH/g of material to about 19 g KOH 1 g of material. It is more preferable for the oxidized polyethylene wax constituent to have a Brookfield viscosity of at least 6000 cps at 150° C., and an acid number of no greater than 20 mg. KOH 1 g of wax. It is preferred if the OPE component has a Brookfield viscosity at 150° C. of between about 8,500 cps to about 85,000 cps and an acid number, as determined by ASTM D 638 and D 6109 of from about 7 mg KOH/g of material to about 20 mg KOH/g of material. A commercially available material which is within this range is AC 316 oxidized polyethylene, and another is AC 307 oxidized polyethylene, both available from Honeywell.

### Zinc Stearate Constituent

Zinc stearate suitable for use in lubricant compositions of the present invention refers to any of the commercially available zinc salts of fatty acid generally recognized as present in “stearic acid”. This includes not only highly pure salts consisting essentially of zinc octadecanoate, but also food grade and technical grade materials which comprise a range of fatty acid zinc salt constituents reflecting the composition of the fatty acid source from which the material was made. These variations will be familiar to those of skill in the art. In general, any zinc stearate which is of a grade and purity acceptable for use as a heat stabilizer in extrudable compositions can be used in compositions of the present invention. A commercially available example of suitable zinc stearate is COAD® zinc stearate from NORAC.

### Optional Paraffin Wax Constituent

When present, the paraffin wax constituent of the lubricant compositions of the invention comprise mixtures of linear and branched aliphatic hydrocarbons of sufficient molecular weight that they are generally solid materials at temperatures lower than about 60° C., and in general have a viscosity greater than 5 centistokes at 100° C. As will be appreciated, paraffin wax is also sometimes termed a hydrocarbon lubricant. Paraffin waxes suitable for use in extrudable compositions are described in Handbook of Plastic Materials and Technology, Ed. I. Rubin, Wiley-Interscience, John Wiley & Sons, Inc. New York, 1990, which is incorporated herein by reference.

A commercially available example of a paraffin wax suitable for use in the present invention compositions may be found in the Rheochem™ series of lubricants available from Honeywell, for example Rheochem m RL-145, RL-165, and RL-185. Other suitable paraffin wax lubricants will be apparent.

### Optional Calcium Stearate Constituent

When present, suitable calcium stearate constituents for use in the compositions of the present invention can be either in the form of a preformed salt, or formed in situ during preparation of a lubricant composition by treating a mixture of composition constituents containing stearic acid with a calcium base. For example, neutralization of free stearic acid with calcium oxide to form the calcium salt.

A second example of the in situ preparation of calcium stearate is by addition of calcium hydroxide and a fatty acid to the composition. In general, when the composition contains fatty acid and calcium hydroxide constituents, the composition is preferably prepared by blending together a wax in liquid form and a fatty acid, followed by a reaction step carried out under conditions in which at least a portion of the fatty acid is neutralized, as dictated by art-recognized variables with regard to the properties desired in the extrudable PVC composition into which the finished additive composition is to be blended. Preferably, the mixing and temperature conditions attained during the blending of the constituents of additive compositions which include a fatty acid and calcium hydroxide are adjusted to insure that the neutralization reaction between the hydroxide and the acid proceeds substantially to completion. Other methods of providing calcium stearate will be apparent.

A commercially available example of a calcium stearate which is suitable for use in the inventive compositions is, for example, COAD 10 calcium stearate from Norac. It will be appreciated that the purity level and grade of the calcium stearate constituent can vary considerably, from a technical grade article of commerce, to a food grade material, to a highly purified material and still be within the scope of the invention.

For use in most extrudable compositions, the lubricant compositions of the present invention comprises from about from about 50 wt. % to about 80 wt. %, more preferably from about 60 wt. % to about 80 wt. %, more preferably from about 50 wt. % to about 70 wt. %, more preferably from about 60 wt. % to about 70 wt. % of ester wax, from about 10 wt. % to about 30 wt. %, more preferably from about 10 wt. % to about 20 wt. % of oxidized polyethylene wax, and some, to about 25 wt. %, preferably from about 1 wt. % to about 25 wt. %, more preferably from about 1 wt. % to about 20 wt. %, and more preferably from about 1 wt. % to about 10 wt. % of zinc stearate. In one preferred embodiment, the lubricant composition of the invention comprises additionally up to an additional 10 wt. % of at least one paraffin wax and up to an additional 25 wt % of calcium stearate. Compositions having amounts lying outside these ranges may also be used as required by the extrudable composition into which the lubricant composition of the present invention is to be incorporated.

In some embodiments, applicants' lubricant composition comprises: (a) ester wax; (b) polyethylene wax; (c) zinc stearate; (d) paraffin wax; and (e) calcium stearate, and the relative amounts of the constituents of the lubricant composition are selected to provide an advantageous increase in the tensile strength of an extrudate product prepared from said composition in comparison to an extrudate product prepared from an extrudable composition substantially lacking one or more of zinc stearate, ester wax, or oxidized polyethylene wax constituents.

In one embodiment, applicants' lubricant compositions comprise:
(a) from about 1 wt. % to about 10 wt. % paraffin wax;
(b) from about 10 wt. % to about 60 wt. % ester wax;
(c) from about 5 wt. % to about 30 wt. % oxidized polyethylene wax;
(d) from about 5 wt. % to about 25 wt. % calcium stearate; and
(e) from about 1 wt. % to about 25 wt % zinc stearate.
   It will be appreciated that, guided by known principles, values of these constituents lying outside of these preferred ranges can be employed and remain within the scope of the invention.

### Additives

As mentioned above, extrudable compositions of the present invention may include also other additives typically included in extrudable compositions, preferably PVC resin, as described above, including those additives which have heat-stabilizing properties and including also those which have internal and external lubricant properties. Herein, these are termed “supplemental” to distinguishing them from the lubricant compositions of the invention which also have lubricating and heat stabilizing properties. Accordingly, the amount of lubricant composition employed and the amounts of constituents comprising the lubricant composition can be adjusted according to amount of supplemental lubricants, stabilizers, etc. in the composition in accordance with known principles.

Examples of supplemental heat stabilizers include any of the supplemental additives known to exert a dynamic heat-stabilizing effect when added to an extrudable PVC composition. Examples of supplemental heat stabilizers suitable for use in the present compositions include those generally used as heat stabilizing additives in extrudable PVC compositions, for example, compounds containing tin, for example, tin mercaptides. Other art-recognized heat stabilizers, for example, those described generally in the Plastics Additives and Modifiers Handbook, Ed. J. Edenbaum, Van Nostrand Reinhold, New York 1992 (which are incorporated herein by reference), for example, those based on lead-based compounds, for example, neutral lead stearate and dibasic lead phosphate. Further examples include “metallic” soaps, for example calcium salts of various fatty acids, and “mixed-metal” soaps, for example calcium/zinc stearates. Additionally, heat stabilizers which are not based on heavy metal salts may be used, for example, organic-based stabilizers (OBS) from Crompton Corporation.

An example of a supplemental lubricant is polyethylene wax homopolymer. Such materials are known and are available from Honeywell under the trade designation AC® series of wax homopolymers.

### Preparation of Extrudable Compositions

The lubricant compositions of the present invention may be prepared by any known means of blending solid, semi-solid, or liquid materials with other solid, semi-solid, or liquid materials.

Conveniently, an extrudable composition can be prepared by placing an amount of resin, preferably a polyvinyl chloride resin (PVC resin) into a blending apparatus, adding in turn the reinforcing constituent(s), the desired supplemental additive constituents, for example, stabilizers, fillers, processing aids, colorants, and pigments, and other ingredients desired in the composition, and adding to the mass the present combination of lubricant constituents. As indicated above, the lubricant components which comprise the present combination can be blended separately, preferably in accordance with the proportions described above and added, in the amounts specified herein, in a single addition as a blend of the lubricant constituents to the above-mentioned resin-containing mixture. Alternatively, the individual components which comprise the present combination may be added separately, at the same time or at different times, to one or more of the other components of the extrudable composition.

Any type of mixing or blending equipment on a scale from manual laboratory bench top scale, for example a hand-held motorized mixer and vessel, to motorized industrial scale processing equipment can be used. Examples of the latter type of equipment include a Henschel mixer, a ribbon blender, and a temperature controlled agitated blend tank.

It will thus be appreciated that the order of mixing the components is not critical. For example, any two or more lubricant components (including all of the lubricant components) which comprise the present lubricant combination may be prepared as an admixture which is added into an extrudable composition of the type described above, or each component may be added, either simultaneously or sequentially, to one or more of the other components of the extrudable composition of the type described above. Alternatively, the resin and various constituents of the extrudable composition could be added to one or more (including all) of the lubricant components of the present lubricant combination. Thus, all such means of bringing the components of the present extrudable composition together are contemplated by the term “adding to” used herein.

In general, the lubricant components of the present combination are present in the extrudable composition such that, in the aggregate, the amount of lubricating components is sufficient to provide an extrudable composition which displays, under the above-described conditions of comparison, one or more of the following extrudability properties: (a) lower equilibrium torque; and (b) lower equilibrium temperature, and/or which provides an extruded article therefrom having improvement in one or more of the following appearance properties: (a) decrease in surface roughness (smoother surface); (b) decrease in water infusion; (c) increase surface gloss; and (d) increased dimensional stability, and at the same time provides for an increase in one or more of the following mechanical properties: (a) tensile strength; (b) flexural strength; (c) modulus of rupture; and (d) apparent modulus of elasticity in an extrudate product prepared from the extrudable composition of the invention when compared to an extruded article prepared from a comparative extrudable composition, as described above, having a substantially similar lubricant loading. It is preferred that the lubricant combination is used in an extrudable composition in an amount that concomitantly reduces the extrudability properties of equilibrium torque and/or equilibrium temperature, as measured by a torque rheometer, and increases one or more of the mechanical properties of an extrudate prepared therefrom including tensile strength, flexural strength, modulus of rupture, and apparent modulus of elasticity (as measured in accordance with ASTM D6109-03 or ASTM D4761-02a). It is preferred to use an amount of the lubricant combination that reduces the at least one of the extrudability properties, by at least about 3% and increases one or more mechanical properties by at least about 10%.

Although this amount will vary, in general it is preferred if the improved composition contains, relative to 100 weight part of extrudable resin (preferably PVC resin) in the extrudable composition, from about 0.1 weight parts per hundred resin (PHR) up to about 0.5 weight parts (PHR) of oxidized polyethylene, from about 0.5 weight parts per hundred resin (PHR) up to about 4.0 weight parts (PHR) of ester wax, and from about 0.1 weight parts per hundred resin (PHR) up to about 2.0 weight parts (PHR) of zinc stearate.

In general, the desired amounts of the various constituents of a lubricant composition will be provided to an extrudable composition by the addition of from about 0.5 to about 6 wt. parts of a lubricant composition described above per hundred weight parts of resin (PHR) in the extrudable composition, preferably from about 1 PHR to about 5.5 PHR of lubricant composition will be added to an extrudable composition and most preferably from about 2.0 PHR to about 5.0 PHR of lubricant composition will be added to the extrudable composition. Greater or lesser amounts may be used, guided by known principles and in consideration of the properties desired of the extrudable composition and the supplemental additives which may be present in an extrudable composition. For example, extrudable compositions into which the lubricant compositions of the present invention are added may also include other internal and external lubricants. Accordingly, the amount of lubricant composition employed will be adjusted to a greater or lesser amount as is warranted by the inclusion or exclusion of other lubricating components.

In one embodiment, the extrudable compositions of the present invention preferably comprise a blend of a plastic composition and a reinforcing agent, the plastic composition comprising:
(a) 100 wt. parts of one or more extrudable resins, preferably comprising and even more preferably consisting essentially of PVC resin;
(b) from about 0.1 PHR to about 5.0 PHR of ester wax, more preferably from about 0.1 PHR to about 3.5 PHR ester wax, and even more preferably from about 0.1 PHR to about 2.0 PHR of ester wax;
(c) from about 0.05 PHR to about 1.4 PHR of oxidized polyethylene wax, more preferably from about 0.05 PHR to about 1.4 PHR of polyethylene wax, and even more preferably from about 0.05 PHR to about 0.6 PHR of oxidized polyethylene wax;
(d) from about 0.1 PHR to about 0.6 PHR of zinc stearate, more preferably from about 0.1 PHR to about 0.5 PHR of zinc stearate, and even more preferably from about 0.1 PHR to about 0.4 PHR of zinc stearate;
(e) optionally, 0.4 PHR to about 2 PHR, preferably from about 0.5 to about 1.5, more preferably from about 0.6 PHR to about 1.0 PHR of paraffin wax;
(f) optionally, from about 0.3 PHR to about 2.4) PHR, preferably from about 0.4 PHR to about 1.5 PHR, more preferably from about 0.5 to about 1.0 PHR of calcium stearate;
(g) optionally, from about 0.4 PHR to about 1.6 PHR, preferably from about 0.5 PHR to about 1.5 PHR, more preferably from about 0.6 to about 1.4 PHR of one or more tin stabilizers;
(h) optionally, up to about 10 PHR, preferably from about 0.5 PHR to about 7.0 PHR, more preferably from about 0.5 to about 5.0 PHR of one or more processing aids;
(i) optionally, up to about 15 PHR, preferably up to about 10 PHR, more preferably up to about 7 PHR of one or more modifiers;
(j) optionally, up to about 15 PHR, preferably from about 1 PHR to about 10 PHR, more preferably from about 2 PHR to about 7 PHR of calcium carbonate; and
(k) optionally, up to about 1 PHR, preferably u ]p to about 0.5 PHR, more preferably up to about 0.1 PHR of one or sore polyethylene wax homopolymer,
wherein the reinforcing agent comprises from about 20 wt. % to about 70 wt. % of the composition, preferably from about 30 wt. % to about 60 wt. % of the composition, more preferably from about 30 wt. % to about 50 wt. % of the composition, and more preferably from about 40 wt. % to about 50 wt. % of the composition, and wherein the reinforcing material preferably comprises and even more preferably consisting essentially of a cellulose reinforcing agent, and even more preferably is wood flour selected from a narrow range of mesh size.

In certain preferred embodiments the extrudable compositions of the present invention preferably comprise a blend of a plastic composition, and a reinforcing agent, wherein the plastic composition comprises:
(a) 100 wt. parts of one or more PVC resin constituents;
(b) from about 0.5 PHR to about 6.0 PHR, more preferably, from about 1.0 to about 5.5 PHR, and more preferably, from about 2.0 to about 5.0 PHR of a lubricant composition comprising:
   (i) from about 50 wt. % to about 80 wt. % of ester wax;
   (ii) from about 5 wt. % to about 50 wt. % of oxidized polyethylene wax; and
   (iii) from about 1 wt. % to about 20 wt. % of zinc stearate; and optionally,
   (iv) from about 10 wt. % to about 20 wt % of calcium stearate; and
   (v) from about 3 wt. % to about 7 wt. % paraffin wax; and optionally,
(c) up to about 15 PHR, preferably from about I PHR to about 10 PHR, more preferably from about 2 PHR to about 7 PHR of calcium carbonate;
(d) from about 0.4 PHR to about 1.6 PHR, preferably from about 0.5 PHR to about 1.5 PHR, more preferably from about 0.6 to about 1.4 PHR of one or more tin stabilizers;
(e) up to about 10 PHR, preferably from about 0.5 PHR to about 7.0 PHR, more preferably from about 0.5 to about 5. 0 PHR of one or more processing aids;
(f) up to about 15 PHR, preferably up to about 10 P AIR, more preferably up to about 7 PHR of one or more modifiers;
(g) from about 0.3 PHR to about 2.0 PHR, preferably from about 0.4 PHR to about 1.5 PHR, more preferably from about 0.5 to about 1.0 PHR of calcium stearate; and
(h) up to about 1 PHR, preferably up to about 0.5 PHR, more preferably up to about 0.1 PHR of one or more polyethylene wax homopolymer constituents,
wherein the reinforcing agent comprises from about 20 wt. % to about 70 wt. % of the composition, preferably from about 30 wt. % to about 60 wt. % of the composition, more preferably from about 30 wt. % to about 50 wt. % of the composition, and more preferably from about 40 wt. % to about 50 wt. % of the composition, and wherein the reinforcing material preferably comprises and even more preferably consisting essentially of a cellulose reinforcing agent, and even more preferably is wood flour selected from a narrow range of mesh size.

### Additive Compositons

The lubricant compositions of the present invention can be added to various supplemental, reinforcing, and resin constituents to provide for an extrudable resin composition. These lubricant compositions can be used in conjunction with existing extrudable resin compositions, for example PVC compositions, as lubricant additives which can provide also improved extrudablity properties and improved physical and mechanic al properties in an extrudate product prepared therefrom. Examples of cellulose-reinforced PVC-containing extrudable compositions to which the lubricant composition of the present invention may be added to provide an extrudable composition of the present invention are described in U.S. Pat. Nos. 6,248,813 and 6,103,791 to Zehner and U.S. Pat. No. 6,210,792 to Seethamraju et al., the disclosures and references of which are incorporated herein by reference.

The above-described lubricant compositions can form the basis of an additive composition which contains in addition to the lubricant constituents, one or more supplemental additives, such as supplemental internal and external lubricants, heat stabilizers, and other constituents of extrudable PVC compositions. The variables governing the selection and amounts of these supplemental additives used in extrudable PVC compositions are described generally in the Plastics Additives and Modifiers Handbook, Ed. J. Edenbaum, Van Nostrand Reinhold, New York 1992, which is incorporated herein by reference. Preferred additive compositions comprise the above-described lubricant composition of the invention and at least one member of the group consisting of compatible supplemental lubricants and compatible supplemental heat stabilizers.

For example, in one embodiment, an additive composition of the present invention may be formulated to comprise substantially all of the constituents, except for the extrudable resin, of an extrudable composition. An additive composition of this type is preferably formulated to be mixed with only an extrudable resin, such as extrudable PVC resin, and thereby provide an extrudable PVC composition. In an alternative embodiment, an additive composition may be formulated to be added to an extrudable PVC composition as one of many additive constituents used to prepare the extrudable composition. In such an embodiment, it is preferred for the present additive composition to further comprise at least some of the most common constituents of extrudable PVC compositions, thereby providing a single additive composition which can be used in a number of different extrudable PVC compositions while reducing the number of addition processes required to prepare an extrudable PVC composition.

It is contemplated that a wide variety of components over a wide range of relative ratios will be adaptable for use in the present invention in view of the teachings contained herein.

As described above for extrudable compositions, additive compositions of the present invention may be prepared by any known means for admixing solid, semi-solid, or liquid materials with other solid, semi-solid, or liquid materials. This includes, but is not limited to, techniques used for the admixture of miscible materials, for example a mixture of two or more components forming a single phase. It includes also techniques used for blending phase separated materials to form an intimate interpenetrating structure of domain-separated regions of two or more immiscible or partially immiscible materials. As will be appreciated also, except for embodiments in which a reaction between two constituents is carried out to generate a constituent of the composition in situ, for example, the provision of a metallic soap lubricant, the various constituents of additive compositions may be blended together in any order and remain within the scope of the invention.

It will be appreciated that extrudable cellulose-reinforced PVC compositions which may be improved by the addition of a lubricant composition of the present development may comprise a wide range of components present in various amounts in accordance with known principles. The processing properties of these compositions will be improved to a varying degree with the addition of an aliquot of the lubricant composition of the present invention. Additionally, the physical properties of articles formed from these compositions will be improved with the addition of a lubricant composition of the present invention to the extrudable composition prior to forming it into an article.

### Exclusion of Amide Wax from Compositions

The inventors have surprisingly found that the mechanical property improvements imparted to extrudate products prepared from extrudable compositions comprising the inventive lubricant composition can be negated, at least to some degree, if an amide wax is also included in an extrudable composition in which the inventive lubricant is present.

As the term is used herein, an amide wax is a lubricant containing one or more amide functional groups. Amide waxes include those provided by condensation of one or more amine species with one or more species of fatty acid. It will be appreciated that included in this category are bisamide waxes, and in particular, ethylene bis-stearamide wax (EBS wax).

Accordingly, in some preferred embodiments, amide wax constituents are avoided in preparing lubricant and extrudable compositions of the invention to preserve the beneficial effect on the mechanical properties of an extruded article made therefrom. In other preferred embodiments, amide wax constituents are substantially completely excluded from the compositions.

In some preferred embodiments, applicants' invention comprises an extrudable composition which is substantially or entirely free of an amide wax. In other preferred embodiments, applicants invention comprises an extrusion process comprising: (a) providing an extrudable composition prepared in accordance with the invention which is further characterized by containing no substantial amount of an amide wax or being entirely free of amide wax; and (b) extruding said extrudable composition. In other preferred embodiments applicants invention comprises an extruded articles prepared by extrusion of an extrudable composition of the invention which is substantially lacking or entirely free of amide wax constituents. In another embodiment, applicant's invention comprises an additive lubricant composition of the invention which contains no substantial amount of amide wax or is entirely free of amide wax constituents.

### EXAMPLES

The following examples illustrate an extrudable composition (Example 1) and a lubricant composition (Example 3) each prepared according to applicants' invention. The examples illustrate also (Example 2) the improved mechanical properties provided by forming an extruded article from applicants' compositions by applicants' method. The examples which follow are presented for the purpose of illustrating the forgoing description and are not meant to limit the scope of the claimed invention.

### Example 1

### Extrudable Compositions

Cellulose reinforced PVC resin-containing extrudable compositions were prepared which contain the components in the weight parts, relative to 100 wt. parts resin (PHR), as shown in Table 1 below. These include Comparative Example A, an extrudable composition containing a proprietary lubricant composition which is commercially sold for PVC lubricating purposes and Comparative Example B, an extrudable composition which contains a bisamide wax constituent and which substantially lacks zinc stearate. Also shown in Table 1 is an extrudable composition (Example 1) which contains a lubricant composition of the present invention.

The materials used to prepare the example and comparative example compositions were as follows PVC resin-containing a reinforcing material were prepared using the following materials: SE 650(polyvinyl chloride resin (K=57) from Shintech; SE 950( D polyvinyl chloride resin (K=65) from Shintech; Mark 1993 0 tin based heat stabilizer (stabilizer) from Crompton; Camel Cal-ST® calcium carbonate from Imerys; Acryloid KM334® acrylic impact modifier (impact modifier) from Rohm & Haas; Durastrength D-510® acrylic impact modifier (impact modifier) from Arkema ; Rheolub® RL 1800 wax from Honeywell (20 wt. % paraffin wax/20 wt. % ester wax/60 wt. % calcium stearate blend), COAD 21® zinc stearate (zinc lubricant) from Norac; oxidized polyethylene wax (OPE) AC®316 A (Honeywell); Ethylene bis-stearamide (bisamide wax) Advawax 280 (Rohm & Haas); 40 mesh wood flour as a cellulose reinforcing component (article of commerce) and Jenkinol L-260 (di stearyl phthalate) from Acme-Hardestry Co., all used as received.

The compositions were prepared by charging the constituent components of a PVC composition into a Papenmeier Mixer (high intensity mixer) equipped with a steam jacket heating system and heating to a temperature in excess of 110° C. while operating the mixing blades. When the components were substantially homogeneously blended, the PVC composition was discharged, cooled to ambient temperature and left to stand for 24 hours (aging period).

At the end of the aging period a portion of the PVC composition was blended with a given percentage of dried wood fiber (See table 1) to form an cellulose fiber reinforced extrudable composition and held for extrusion. The extrudability properties of the Example 1 extrudable composition were observed to be substantially similar to the comparative example composition. This is to say that the extruder settings needed to extrude the Example 1 and comparative example extrudable compositions was found to be substantially the same. Examination of an extruded article prepared from the two compositions showed that the article prepared from the Example 1 composition displayed more uniform dispersion of the wood fiber when a cross-section of the article was compared to a cross-section of an article prepared from the Comparative Example composition.

TABLE I

| | | Comp. | Comp. |
|---|---|---|---|
| Constituent* | Example I | Ex. A | Ex. B |
| Ester Wax | 2.00 | 0.50 | |
| (distearyl phthalate/ | 0.04 | 0.10 | |
| pentaerythritol distearate) | | | |
| High Density Oxidized | 0.60 | 0.20 | |
| Polyethylene Wax | | | |
| Zinc Stearate | 0.40 | X | |
| Paraffin Wax | 0.22 | 0.70 | |
| Calcium Stearate | 2.20 | 0.74 | |
| Amide Wax | X | 0.50 | |
| (ethylene bis-stearamide) | | | |
| Proprietary Lubricant | | | 4.2 |
| PVC Resin | 100.0 | 100.0 | 100.0 |
| | (K** = 65) | (K** = 65) | (K** = 57) |
| Tin Stabilizer | 1.5 | 1.5 | 3.0 |
| Impact Modifier | 3.0 | 3.0 | 3.0 |
| | (KM-334) | (D-510) | (KM-334) |
| Calcium Carbonate | 3.0 | 3.0 | 3.0 |
| Wood fiber | 40.0 | 40.0 | 40.0 |

*The amount of constituent shown is weight parts of constituent in the composition relative to 100 weight parts of PVC resin.
**“K” indicates the Filentscher K-value of the resin utilized

### Example 2

### Preparation of Extruded Articles

Extruded articles were prepared from aliquots of each extrudable composition prepared above (Example 1 and Comparative Examples A and B). For each extrudable composition, an aliquot of the composition was placed into a 28 mm parallel twin screw lab extruder fitted with a rectangular profile die having nominal dimensions of 0.3 inches×1.3 inches. The extruder was operated under fixed conditions and a retangular profile extrudate was formed from each extrudable composition. The extruded profile was cooled by water spray and cut into 3 foot lengths for mechanical testing.

The extruded shapes from each extrudable composition were then cut to a specified length to prepare specimens according to the ASTM standards. The specimens were then subjected to testing of their flexural properties, apparent modulus of elasticity and modulus of rupture, according to ASTM D 6109-97. Additionally, they were visually evaluated for surface roughness and appearance and tested for gloss according to ASTM D 638.

The dimensions of the test specimens and the modulus of rupture and apparent modulus of elasticity test results are presented in Table 2. These data show that the article formed from the extrudable composition of the Example 1 formulation possessed increases in both modulus of rupture and apparent modulus of elasticity, that is, generally, increased flexural strength. Together with the data described above, these data demonstrate that the lubricant composition of the present invention provides an improvement in the lubricating properties imparted to the extrudable composition, as indicated by the improved extrudability of the composition, and as well improves interaction between the reinforcing material and the PVC resin in the composition, as indicated by the improved flexural properties. All extruded articles prepared from the composition of the invention had an acceptably smooth surface appearance.

TABLE 2

| | Dimensions | | Apparent | Maximum |
|---|---|---|---|---|
| | Test Sample* | Modulus of | Modulus | Load |
| | Cross Section | Rupture | of Elasticity | (pound- |
| Ex. No. | (inches) | (PSI***) | (KPSI**) | feet) |
| Example 1 | 1.124 × 0.314 | 7,023 | 782.01 | 155.24 |
| Comp. Ex. A | 1.141 × 0.327 | 5,044 | 558.77 | 123.38 |
| Comp. Ex. B | 1.151 × 0.329 | 5,834 | 681.65 | 145.66 |

*Test sample is a bar with a rectangular cross section.
**KPSI = thousand pounds per square inch.
***PSI = pounds per square inch.

### Example 3

### Preparation of Additive Compositions

Additive lubricant compositions of the invention will be prepared by placing the constituents, in the amounts shown in Table 3, into a vessel equipped with low intensity mixing blades and with a steam heating jacket and heating the constituents in excess of 110° C. while operating the mixing blades of the mixer. When these compositions are added to an extrudable composition comprising a PVC resin and a wood reinforcing material, in an amount providing acceptable extrudability properties, it will be found that extruded articles prepared therefrom have improved mechanical properties.

TABLE 3

| Constituent* | Example 3a | Example 3b |
|---|---|---|
| Ester Wax (distearyl phthalate/ | 50 | 70 |
| pentaerythritol distearate) | 5 | X |
| High Density Oxidized Polyethylene Wax | 15 | 20 |
| Zinc Stearate | 10 | 10 |
| Paraffin Wax | 5 | X |
| Calcium Stearate | 15 | X |

*The amount of constituent shown is weight percent of constituent in the composition.

What is claimed is:

1. An shapeable composition comprising:
(a) thermoplastic resin;
(b) reinforcing agent; and
(c) ester wax,
wherein the wax is present in the composition to a level of at least about 0.1 wt. parts per hundred weight parts (PHR) of said resin.

2. The composition of claim 1 wherein the ester wax is present from about 0.1 PHR to about 5.0 PHR.

3. The composition of either claim 1 or claim 2 further comprising oxidized polyethylene wax and zinc stearate.

4. An extrudable composition comprising:
(a) thermoplastic resin;
(b) reinforcing agent;
(c) ester wax;
(d) oxidized polyethylene;
(e) zinc stearate;
(f) optionally, paraffin wax; and
(g) optionally, calcium stearate.

5. The composition of claim 4 wherein said thermoplastic resin comprises polyvinyl chloride resin (PVC) and said reinforcing agent is a cellulose reinforcing agent.

6. The composition of claim 5 wherein the relative amounts of said constituents (c), (d), and (e) are selected to provide an advantageous increase in one or more of the mechanical properties (as measured in accordance with ASTM D6109-97e1 or ASTM D4761-02a) selected from the group consisting of modulus of rupture, apparent modulus of elasticity, tensile strength, and flexural strength of an extruded article prepared from said composition in comparison to an extruded article prepared from an extrudable composition substantially lacking one or more said (c), (d), and (e) constituents.

7. The composition of claim 6 wherein said components (c), (d) and (e) together are present in an amount effective to improve one or more shapeability characteristics of the composition relative to the same composition but lacking said combination of components (c), (d) and (e), said one or more improved shapeablity characteristics being selected from the group consisting of:
i. decreased shaping pressure for given shaping conditions;
ii. reduced equilibrium temperature; and
iii. reduced fusion torque.

8. The composition of claim 6 wherein composition is an extrudable composition and said components (c), (d) and (e) together are present in an amount effective to improve one or more extrudability characteristics of the composition relative to the same composition but lacking said combination of components (c), (d) and (e), said one or more improved extrudability characteristics being selected from the group consisting of:
i. decreased extrusion pressure for given die and extrusion rate;
ii. reduced extruder head pressure for a given die and extrusion rate;
iii. reduced extrusion torque for a given die and extrusion rate
iv. reduced equilibrium temperature; and
v. reduced fusion torque.

9. The extrudable composition of claim 8 wherein said combination of components (c), (d) and (e) together are present in an amount effective to improve one or more appearance characteristics of an extruded article prepared from said extrudable composition relative to the same composition but lacking said combination of components (c), (d) and (e), said one or more improved characteristics being selected from the group consisting of:
a) reduced water infusion;
b) decreased surface roughness;
c) increased surface gloss;
d) improved dimensional stability.

10. The extrudable composition of claim 8 wherein the type and amount of components (c), (d), and (e) are selected to provide increase in both modulus of rupture and apparent modulus of elasticity.

11. The extrudable composition of claim 8 wherein at least one of said effected extrudability characteristic is improved by at least about 5 percent.

12. The composition of claim 5 wherein said reinforcing agent is present in an amount of from about 30 wt. % to about 60 wt. % of the composition and the balance is a plastic composition comprising:
(a) 100 weight parts PVC resin;
(b) from about 0.1 weight parts to about 5.0 weight parts of ester wax per hundred weight parts resin (PHR);
(c) from about 0.05 PHR to about 1.4 PHR oxidized polyethylene;
(d) from about 0.1 PHR to about 0.6 PHR zinc stearate.

13. The composition of claim 11 which additionally comprises from about 0.5 PHR to about 1.5 PHR of paraffin wax and from about 0.3 PHR to about 2.0 PHR of calcium stearate.

14. The composition of claim 4 further characterized in that it comprises no substantial amount of amide wax.

15. The composition of claim 6 wherein said composition is an extrudable composition and wherein the combination of (c), (d) and (e) components is present in an amount effective to reduce the apparent viscosity of said extrudable composition relative to the same composition in the substantial absence of said combination of (c), (d), and (e) components.

16. The extrudable composition of claim 15 comprising from about 0.1 PHR to about 3.5 PHR ester wax, from about 0.05 PHR to about 1.4 PHR oxidized polyethylene wax homopolymer and from about 0.1 PHR to about 0.5 PHR zinc stearate.

17. The composition of claim 4 wherein said oxidized polyethylene comprises a major proportion of oxidized polyethylene having an acid number of from about 7 to about 20 mg KOH/g and a viscosity of from about 8,500 to about 85,000 cP at 150° C.

18. The composition of claim 4 wherein the oxidized polyethylene component has an acid number of from about 10 to about 20 mg KOH/g and a viscosity of from about 200 cps to about 1,000 cps at 140° C .

19. The of claim 4 wherein the ester wax has an acid number of from about 10 to about 14 mg KOH/g and a viscosity of 50 cSt at 240° F.

20. The composition of claim 5 wherein said combination of components (c), (d) and (e) together comprise from about 0.25 PHR to about 7.0 PHR.

21. A process for preparing an extruded article comprising providing the composition of claim 6 and extruding said composition.

22. A process for preparing an shapeable product comprising:
a. providing an shapeable composition comprising: (a) at least one resin characterized in that it undergoes plastic flow; (b) at least one reinforcing agent; (c) ester wax; (d) oxidized polyethylene wax; (e) zinc stearate; (f) optionally paraffin wax; and (g) optionally calcium stearate; and
b. shaping said shapeable composition.

23. The process of claim 22 wherein said shapeable composition is further characterized in that it contains no substantial amount of amide wax.

24. The process of claim 22 wherein said reinforcing agent comprises cellulose reinforcing agent and said resin comprise PVC resin.

25. A product made from the composition in accordance with claim 4 wherein the product has an increased modulus of rupture and/or apparent modulus of elasticity relative to a product prepared from the same composition but substantial lacking one or more of said components (c), (d), and (e).

26. The product of claim 25, further characterized in that it comprises no substantial amount of amide wax

27. An extruded product made from the shapeable composition in accordance with claim 6.

28. The extruded product of claim 27 wherein said increased mechanical property is an increase of at least about 10 percent.

29. An additive lubricant composition comprising:
a. from about 50 wt. % to about 80 wt. % ester wax;
b. from about 10 wt. % to about 30 wt. % oxidized polyethylene wax; and
c. from about 1 wt. % to about 25 wt. % zinc stearate.

30. The lubricant composition of claim 29 further characterized in that it comprises no substantial amount of amide wax and comprises additionally (i) from about 1 wt. % to about 10 wt. % paraffin wax; and (ii) from about 5 wt. % to about 25 wt. % calcium stearate.

31. The lubricant composition of claim 29 wherein said oxidized polyethylene comprises at least a major proportion of oxidized polyethylene having a Brookfield viscosity of at least about 6000 cps at 140° C.

32. The lubricant composition of claim 31 wherein the oxidized polyethylene wax has an acid number of from about 7 mg KOH/g to about 20 mg KOH/g and a viscosity of from about 8,500 cps at 150° C. to about 85,000 cps at 150° C.

33. The lubricant composition of claim 31 wherein the ester wax is selected from the group consisting of distearyl phthalate, penta-erythritol-adipate-stearate, penta-erythritol-adipate-oleate, penta-erythritol-tetrastearate, penta-erythritol-monostearate, and penta-erythritol distearate, and mixtures of any two or more thereof.

34. A shapeable composition comprising PVC resin, reinforcing agent and the lubricant composition according to claim 31, said lubricant composition being present in the shapeable composition in an amount sufficient to provide an advantageous increase in one or more of the mechanical properties (as measured in accordance with ASTM D6109-97e 1 or ASTM D4761-02a) selected from the group consisting of modulus of rupture, apparent modulus of elasticity, tensile strength, and flexural strength of a shaped article prepared from said composition in comparison to a shaped article prepared from a shapeable composition substantially lacking one or more said ester wax, oxidized polyethylene wax, and zinc stearate constituents.

35. The shapeable composition of claim 34 wherein said lubricant composition is present in an amount sufficient to promote wetting of the reinforcing agent, as measured with respect to the smooth appearance of a shaped product formed from the composition.

36. The shapeable composition of claim 45 wherein the composition is an extrudable composition and wherein said lubricant composition is present in an amount sufficient to promote wetting of the reinforcing agent as measured by an increase in one or more mechanical properties (as measured in accordance with ASTM D6109-97e1 or ASTM D4761-02a) selected from the group consisting of modulus of rupture, apparent modulus of elasticity, tensile strength, and flexural strength of an extruded article prepared from said composition in comparison to an extruded article prepared from an extrudable composition substantially lacking one or more said (c), (d), and (e) constituents.

37. An extrudable composition comprising a blend of a reinforcing agent comprising wood flower and a plastic composition comprising:
(a) 100 weight parts PVC resin;
(b) from about 1.0 PHR to about 5.5 PHR of the lubricant composition of claim 37;
(c) from about 1 PHR to about 10 PHR of calcium carbonate;
(d) from about 0.5 PHR to about 1.5 PHR of a tin stabilizer;
(e) from about 0.5 PHR to about 5.0 PHR of at least one processing aid; and
(f) optionally, up to about 10 PHR of an impact modifier,
wherein the reinforcing agent is present in the composition to a level of from about 20 wt. % of the composition to about 60 wt. % of the composition.

38. An article comprising:
(a) thermoplastic resin;
(b) reinforcing agent; and
(c) ester wax,
which is further characterized by an apparent modulus of elasticity, as measured in accordance with ASTM D6109-03, of at least about 780,000 psi.

39. The article of claim 38 formed by extrusion.

40. The article of claim 38 further characterized by having a modulus of rupture, as measured in accordance with ASTM D6109-03, of at least about 7,000 psi.

41. The article of a claim 40 further comprising oxidized polyethylene wax and zinc stearate.

42. The article of claim 41 further characterized by a low potential for water infusion as determined by ASTM D570-98.
